(19) United States
(12) Patent Application Publication
(10) Pub. No.: US 2011/0180336 A1
(43) Pub. Date: Jul. 28, 2011

(54) VEHICLE MOTOR DRIVING SYSTEM

(75) Inventor: Fumito Kurata, Shizuoka-ken, (JP)

(73) Assignee: TOYOTA JIDOSHA KABUSHIKI KAISHA, Toyota-shi, Aichi-ken (JP)

(21) Appl. No.: 13/059,901

(22) PCT Filed: Sep. 29, 2009
(86) PCT No.: PCT/IB2009/006985

§ 371 Date: Feb. 18, 2011

(30) Foreign Application Priority Data
Sep. 30, 2008 (JP) 2008-254977

(51) Int. Cl. B60K 1/00

(52) U.S. Cl. 180/65.1

(57) ABSTRACT

A vehicle motor driving system includes a motor that is installed to an unsprung vehicle body and that generates power for rotating a wheel by being fed with electric power, an inverter that is installed to a sprung vehicle body and that converts direct-current electric power into alternating-current electric power and then feeds the electric power to the motor, and a shielded wire as a power cable that electrically connects the motor to the inverter. A shield layer of the shielded wire is grounded at least one of a location near a connecting portion at which a motor case that accommodates the motor is connected to a suspension arm and a location near a mounting portion at which a hub bearing is mounted in the motor case.

### BACKGROUND OF THE INVENTION

1. Field of the Invention

The invention relates to a vehicle motor driving system and, more particularly, to a vehicle motor driving system that uses a shielded wire as a power cable that electrically connects a motor, which is installed to an unsprung vehicle body and generates power for rotating a wheel by being fed with electric power, and an inverter, which is installed to the sprung vehicle body and converts direct-current electric power into alternating-current electric power and then feeds the power to the motor.

2. Description of the Related Art

For example, Japanese Patent Application Publication No. 2006-80215 (JP-A-2006-80215) describes a vehicle motor driving system. The vehicle motor driving system includes a motor, an inverter and shielded wires. The motor generates power for rotating a wheel by being fed with electric power. The inverter converts direct-current electric power into alternating-current electric power and then feeds the power to the motor. The shielded wires serve as power cables that electrically connect the motor to the inverter. In the above system, a shield layer of each shielded wire is grounded to an inverter case via a high-frequency reactor. The inverter case accommodates the inverter. The inverter case is connected to a vehicle body. The high-frequency reactor absorbs high-frequency potential fluctuations generated in each shielded wire. This suppresses propagation of high-frequency noise, generated in each shielded wire, to the vehicle body.

However, the high-frequency reactor is generally expensive, and has a shape such that a conductor is wound around a core, so installation space increases. In addition, there is radiation noise radiated from the reactor itself, so it is necessary to provide a shield that covers the reactor. In this respect, the above described system causes an increase in cost and an enlargement and complication of the structure in order to suppress propagation of high-frequency noise, generated in each shielded wire, to the vehicle body.

### SUMMARY OF THE INVENTION

The invention provides a vehicle motor driving system that is able to suppress propagation of high-frequency noise to a vehicle body with a simple and low-cost configuration.

A first aspect of the invention provides a vehicle motor driving system. The vehicle motor driving system includes: a motor that is installed to an unsprung vehicle body and that generates power for rotating a wheel by being fed with electric power; an inverter that is installed to a sprung vehicle body and that converts direct-current electric power into alternating-current electric power and then feeds the electric power to the motor; and a shielded wire as a power cable that electrically connects the motor to the inverter. A shield layer of the shielded wire is grounded at least one of a location near a connecting portion at which a motor case that accommodates the motor is connected to a suspension arm and a location near a mounting portion at which a hub bearing is mounted in the motor case.

In the above aspect, the shield layer of the shielded wire as the power cable that electrically connects the motor to the inverter is grounded at least one of the location near the connecting portion at which the motor case is connected to the suspension arm and the location near the mounting portion at which the hub bearing is mounted in the motor case. In the above configuration, high-frequency noise generated in the shielded wire is attenuated by electrical resistance of a suspension bushing or wheel tire. Thus, propagation of the high-frequency noise to the vehicle body is suppressed. In this case, propagation of high-frequency noise to the vehicle body is suppressed only by specifically setting a grounding point at which the shield layer is grounded to the motor case. Therefore, with the above aspect, it is possible to suppress propagation of high-frequency noise to the vehicle body with a simple and low-cost configuration.

In addition, in the vehicle motor driving system according to the first aspect, the motor may be a three-phase alternating-current motor, the number of the shielded wires may be three, the three shielded wires may be independently provided respectively for three phases of the three-phase alternating-current motor, motor-side ends of the shield layers of the two shielded wires among the three shielded wires may be connected to each other, inverter-side ends of the shield layer of any one of the two shielded wires, of which the motor-side ends of the shield layers are connected, and the shield layer of the remaining one shielded wire among the three shielded wires may be connected to each other, and the motor-side end of the shield layer of the remaining one shielded wire independent of the motor-side ends of the other shield layers may be grounded at least any one of the location near the connecting portion at which the motor case is connected to the suspension arm and the location near the mounting portion at which the hub bearing is mounted in the motor case.

In the above aspect, the three shielded wires are arranged in parallel with one another between the motor and the inverter and the shield layers of them are connected in series. In the above structure, when noise is superimposed from a noise source present outside the shielded wires to each of the three shielded wires, noise current flows between the motor and inverter in the same direction in each shielded wire. Then, noise currents flowing through the two shielded wires cancel each other to reduce noise, received from the outside by the power cables, to one third. Therefore, in comparison with the configuration that three shielded wires are merely arranged adjacent to one another between the motor and the inverter, propagation of externally generated noise to the vehicle body is suppressed. In this case, propagation of noise to the vehicle body is suppressed only by specifically setting connection of the ends of the shield layers of the three shielded wires. Thus, with the above aspect, it is possible to suppress propagation of noise to the vehicle body with a simple and low-cost configuration.

A second aspect of the invention provides a vehicle motor driving system. The vehicle motor driving system includes: a motor that is installed to an unsprung vehicle body and that generates power for rotating a wheel by being fed with electric power; an inverter that is installed to a sprung vehicle body and that converts direct-current electric power into alternating-current electric power and then feeds the electric power to the motor; and a shielded wire as a power cable that electrically connects the motor to the inverter. A shield layer of the shielded wire is grounded via a relay conductor to at least one of a suspension arm, a stabilizer and a suspension member, on each of which bushings are respectively provided at both ends.

In the above aspect, the shield layer of the shielded wire as the power cable that electrically connects the motor to the inverter is grounded via the relay conductor to at least any one of the suspension arm, the stabilizer and the suspension member, on each of which bushings are respectively provided at both ends. In the above structure, high-frequency noise generated in the shielded wire propagates via the relay conductor to at least any one of the suspension arm, the stabilizer and the suspension member; however, the high-frequency noise is attenuated by electrical resistance of the bushings, so propagation of the high-frequency noise to the motor case or the vehicle body is suppressed. In this case, propagation of high-frequency noise is suppressed only by specifically setting a grounding point of the shield layer. Therefore, with the above aspect, it is possible to suppress propagation of high-frequency noise to the motor case or the vehicle body with a simple and low-cost configuration.

In addition, in the vehicle motor driving system according to the second aspect, the relay conductor may be arranged at a middle location between the motor and the inverter, and the relay conductor may relay a shielded wire, which electrically connects the motor to the relay conductor, to a shielded wire, which electrically connects the inverter to the relay conductor.

A third aspect of the invention provides a vehicle motor driving system. The vehicle motor driving system includes: a motor that is installed to an unsprung vehicle body and that generates power for rotating a wheel by being fed with electric power; an inverter that is installed to a sprung vehicle body and that converts direct-current electric power into alternating-current electric power and then feeds the electric power to the motor; and a shielded wire as a power cable that electrically connects the motor to the inverter. The vehicle motor driving system includes a rubber member that is part of a fixture for fixing one end of the shielded wire to a motor case that accommodates the motor, that is connected to a shield layer of the shielded wire, and that has a conductivity lower than or equal to a predetermined volume resistivity. The shield layer of the shielded wire is grounded to the motor case via the rubber member.

In the above aspect, one end of the shielded wire as the power cable that electrically connects the motor to the inverter is fixed to the motor case using the rubber member having a conductivity lower than or equal to the predetermined volume resistivity, and the shield layer of the shielded wire is grounded to the motor case via the rubber member. In the above structure, the shielded wire is flexibly connected between the motor and the inverter. Therefore, even when a relative displacement occurs between the sprung vehicle body and the unsprung vehicle body, durability of the shielded wire is ensured. In addition, high-frequency noise generated in the shielded wire is attenuated by electrical resistance of the conductive rubber member, while the high-frequency noise propagates to the motor case. Therefore, propagation of the high-frequency noise to the vehicle body is suppressed. In this case, propagation of high-frequency noise to the vehicle body is suppressed only by grounding the shield layer to the motor case via the conductive rubber member. Therefore, with the above aspect, it is possible to suppress propagation of high-frequency noise to the vehicle body with a simple and low-cost configuration.

In addition, in the vehicle motor driving system according to the third aspect, the predetermined volume resistivity may be about 1×10⁻⁵ Ωm.

In addition, in the vehicle motor driving system according to the third aspect, the rubber member may be silicon rubber.

In addition, in the vehicle motor driving system according to the first to third aspects, a suspension bushing, provided at a connecting portion at which the unsprung vehicle body is connected to the sprung vehicle body, may have a rubber member as part of the suspension bushing, and the rubber member may have a conductivity lower than or equal to a predetermined volume resistivity.

In the above aspect, the shield layer of the shielded wire is connected via the rubber member of the suspension bushing to the portion located to the sprung vehicle body. In the above structure, high-frequency noise generated in the shielded wire is attenuated by the rubber member when propagating via the suspension bushing to the sprung vehicle body. In this case, propagation of high-frequency noise to the vehicle body is suppressed by providing the conductive rubber member for the suspension bushing. Therefore, with the above aspect, it is possible to suppress propagation of high-frequency noise to the vehicle body with a simple and low-cost configuration.

In addition, in the vehicle motor driving system according to the above aspect, the predetermined volume resistivity may be about 1×10⁻⁵ Ωm.

In addition, in the vehicle motor driving system according to the above aspect, the rubber member may be silicon rubber.

A fourth aspect of the invention provides a vehicle motor driving system. The vehicle motor driving system includes: a motor that is installed to an unsprung vehicle body and that generates power for rotating a wheel by being fed with electric power; an inverter that is installed to a sprung vehicle body and that converts direct-current electric power into alternating-current electric power and then feeds the electric power to the motor; a power feeding shielded wire as a power cable that electrically connects the motor to the inverter; sensors that are arranged in a motor case that accommodates the motor; a controller that is installed to the sprung vehicle body; and a signal shielded wire as a signal line that electrically connects the sensors to the controller. A shield layer of the power feeding shielded wire is grounded at least one of a location near a connecting portion at which the motor case is connected to a suspension arm and a location near a mounting portion at which a hub bearing is mounted in the motor case. The shield layer of the signal shielded wire is grounded to the sprung vehicle body.

In the above aspect, the shield layer of the power feeding shielded wire as the power cable that electrically connects the motor to the inverter is grounded at the location near the connecting portion at which the motor case is connected to the suspension arm and the location near the mounting portion at which the hub bearing is mounted in the motor case. In addition, the shield layer of the signal shielded wire as the signal line that electrically connects the sensors in the motor case to the controller on the sprung vehicle body is grounded to the sprung vehicle body but is not grounded at the motor case side. In the above structure, high-frequency noise generated in the power feeding shielded wire is attenuated by electrical resistance of the suspension bushing or wheel tire, and it is hard for the high-frequency noise to be transmitted to the signal shielded wire via the motor case. Thus, propagation of the high-frequency noise to the vehicle body or the signal shielded wire is suppressed. In this case, propagation of high-frequency noise is suppressed only by specifically setting grounding points of the shield layers of the power feeding shielded wire and signal shielded wire. Thus, with the above aspect, it is possible to suppress propagation of high-frequency noise, generated in the power feeding shielded wire, to the vehicle body or the signal shielded wire with a simple and low-cost configuration.

In addition, in the vehicle motor driving system according to the fourth aspect, an inverter-side end of the power feeding shielded wire may be insulated from the sprung vehicle body, and a motor-side end of the signal shielded wire may be insulated from the unsprung vehicle body.

In addition, the vehicle motor driving system according to the fourth aspect may further include an insulating member that covers the sensors so as to electrically isolate the sensors from the motor case.

In the above aspect, the sensors are electrically isolated from the motor case because of the presence of the insulating member. Thus, propagation of high-frequency noise generated in the power feeding shielded wire to the signal shielded wire via the motor case is reliably prevented.

According to the aspects of the invention, it is possible to suppress propagation of high-frequency noise to the vehicle body with a simple and low-cost configuration.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a cross-sectional view of a relevant portion of a vehicle equipped with a vehicle motor driving system according to a first embodiment of the invention;

FIG. 2 is a configuration diagram of the vehicle motor driving system according to the first embodiment of the invention;

FIG. 3 is a cross-sectional view of a terminal block case to which shielded wires of the vehicle motor driving system according to the first embodiment of the invention are connected;

FIG. 4A and FIG. 4B are configuration diagrams of a suspension arm of the vehicle motor driving system according to the first embodiment of the invention;

FIG. 5 is a configuration diagram of a vehicle motor driving system according to a second embodiment of the invention;

FIG. 6A and FIG. 6B are cross-sectional views of terminal block cases to which shielded wires of the vehicle motor driving system according to the second embodiment of the invention are connected;

FIG. 7 is a configuration diagram of a vehicle motor driving system according to a third embodiment of the invention;

FIG. 8 is a cross-sectional view of a relay box case to which shielded wires of the vehicle motor driving system according to the third embodiment of the invention are connected;

FIG. 9A and FIG. 9B are perspective views of the overall vehicle motor driving system according to the third embodiment of the invention;

FIG. 10 is a configuration diagram of a vehicle motor driving system according to a fourth embodiment of the invention;

FIG. 11 is a cross-sectional view of a terminal block case to which shielded wires of the vehicle motor driving system according to the fourth embodiment of the invention are connected;

FIG. 12 is a configuration diagram of a vehicle motor driving system according to a fifth embodiment of the invention;

FIG. 13 is a configuration diagram of a vehicle motor driving system according to an alternative embodiment of the invention; and

FIG. 14 is a cross-sectional view of a relevant portion of the vehicle motor driving system according to the alternative embodiment of the invention.

### DETAILED DESCRIPTION OF EMBODIMENTS

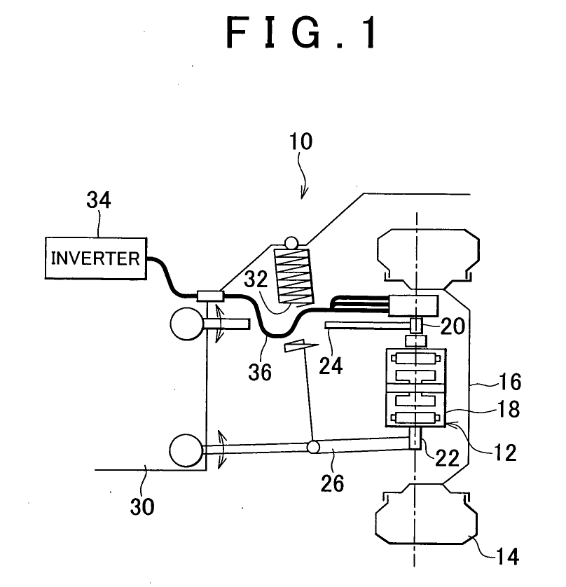

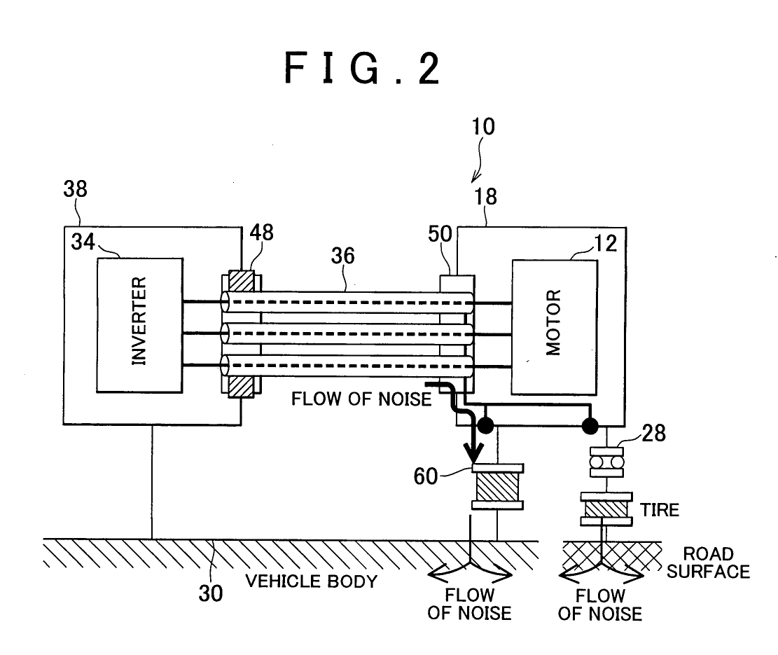

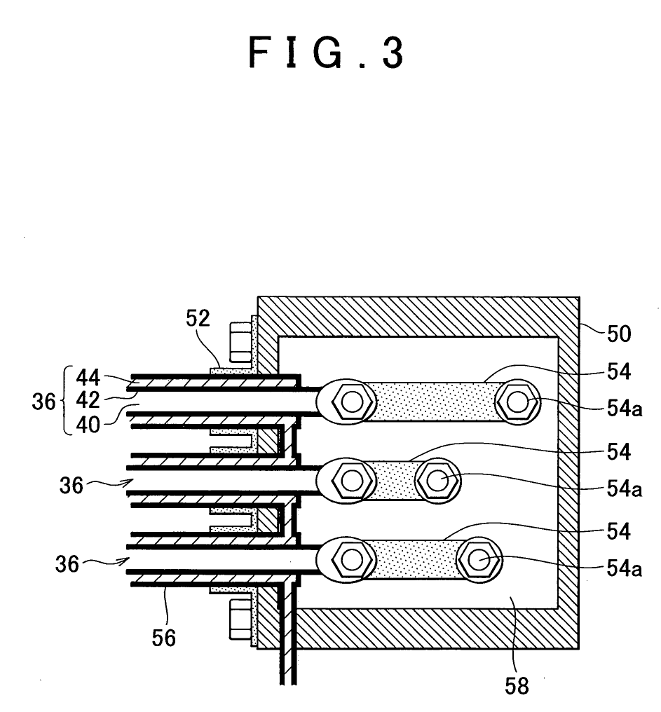

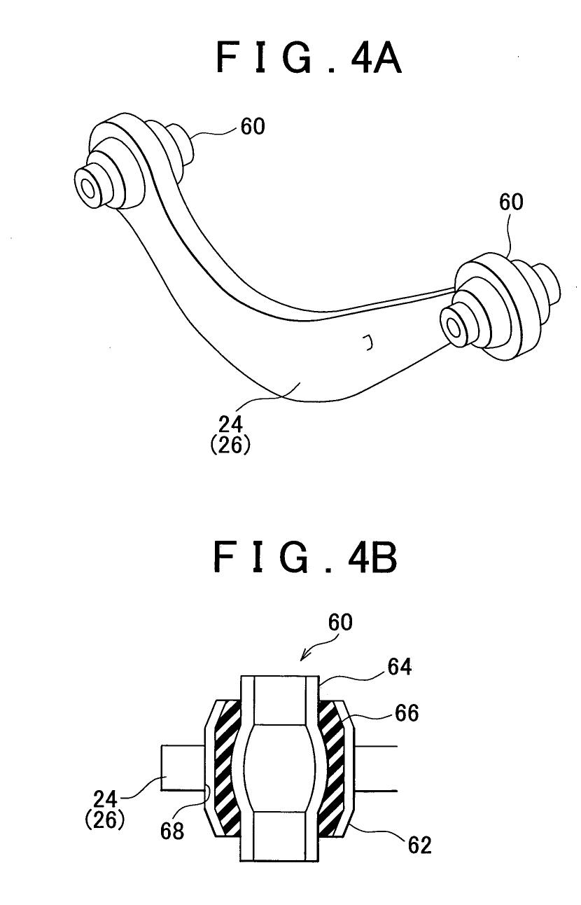

FIG. 1 is a cross-sectional view of a relevant portion of a vehicle equipped with a vehicle motor driving system 10 according to a first embodiment of the invention. FIG. 2 is a configuration diagram of the vehicle motor driving system 10 according to the first embodiment. FIG. 3 is a cross-sectional view of a terminal block case to which shielded wires of the vehicle motor driving system 10 according to the first embodiment are connected. FIG. 4A and FIG. 4B are configuration diagrams of a suspension arm of the vehicle motor driving system 10 according to the first embodiment. Note that FIG. 4A shows a perspective view of the suspension arm, and FIG. 4B shows a cross-sectional view of a suspension bushing.

The vehicle motor driving system 10 is, for example, mounted on an electric vehicle, or the like. The vehicle motor driving system 10 converts direct-current electric power from an in-vehicle power source into alternating-current electric power using an inverter and then feeds the electric power to an in-vehicle motor, thus driving the motor. As shown in FIG. 1, the vehicle motor driving system 10 includes a driving target motor 12. The motor 12 is a driving motor provided for each driving wheel 14 of a vehicle. The motor 12 is a driving electric motor that generates power for rotating a corresponding one of the driving wheels 14 by being fed with electric power, and is an in-wheel motor provided inside a wheel of each driving wheel 14.

Each motor 12 is accommodated in a motor case 18, which is a conductive metal casing. The motor case 18 is coupled to suspension arms 24 and 26 via ball joints 20 and 22, and is connected to the wheel 16 of the driving wheel 14 via a hub bearing 28. One ends of the suspension arms 24 and 26 are coupled to the driving wheel 14 via the ball joints 20 and 22, and the other ends are pivotably fixed to a vehicle body 30, which serves as a sprung vehicle body. The suspension arm 26 is further coupled to the vehicle body 30 via a spring 32. The motor case 18, that is, the motor 12 and the driving wheel 14, are suspended by the vehicle body 30. The motor 12 is installed to the unsprung vehicle body.

The motor 12 is a three-phase alternating-current motor formed of a U phase, a V phase and a W phase. An inverter 34, which is an electric power conversion device, is electrically connected to the motor 12 via shielded wires 36, which serve as power cables. The inverter 34 converts direct-current electric power, supplied from a vehicle power source such as an in-vehicle battery, into three-phase alternating-current electric power and then supplies the electric power to the motor 12. The inverter 34 is accommodated in an inverter case 38, which is a conductive metal casing. The inverter case 38 is fixed to the vehicle body 30, which serves as the sprung vehicle body, by a bolt, or the like, and is grounded to the vehicle body 30. The inverter 34 is mounted on the vehicle body 30, which serves as the sprung vehicle body.

The shielded wires 36 are power cables that are independently provided in correspondence with the three phases and that flow electric power of each phase from the inverter 34 to the motor 12. The shielded wires 36 are flexible and are able to follow a relative displacement between the inverter 34 and the motor 12 (that is, between the sprung vehicle body and the unsprung vehicle body). Each shielded wire 36 includes a core wire 40, a cylindrical insulating member 42, and a shield layer 44. The insulating member 42 covers the core wire 40. The shield layer 44 covers the outer peripheral side of the insulating member 42. The shield layer 44 is formed of a conductive metal, and is, for example, formed by braiding metal thin wires on the outer peripheral side of the insulating member 42. The shield layer 44 has a function of shielding electromagnetic waves radiated from the core wire 40 to the outside.

The inverter-side ends of the three shielded wires 36 are fixed to the inverter case 38 by a cable mounting bracket, and are insulated from the inverter case 38 by the insulating member 48. The inverter-side ends of the core wires 40 of the three shielded wires 36 are connected to corresponding inverter output terminals in the inverter case 38. These output terminals are connected to cables connected to the inverter 34 in the inverter case 38.

In addition, the motor-side ends of the three shielded wires 36 are fixed to a conductive metal terminal block case 50 by a cable mounting bracket 52, and are insulated from the terminal block case 50 by insulating members 42 and 56. The terminal block case 50 is integrally fixed to the motor case 18. The motor-side ends of the core wires 40 of the three shielded wires 36 are connected to corresponding bus bars 54 provided on an insulator 58 in the terminal block case 50. These bus bars 54 are connected at the motor-side terminals 54a thereof to the cables connected to the motor 12 in the motor case 18. In addition, the motor-side ends of the shield layers 44 of the three shielded wires 36 are electrically connected to one another in the terminal block case 50.

The inverter-side ends of the shield layers 44 of the three shielded wires 36 are insulated from the inverter case 38, and the motor-side ends of the shield layers 44 are insulated from the terminal block case 50. On the other hand, the shield layers 44 are grounded near connecting portions coupled to the suspension arms 24 and 26 of the motor case 18, and are grounded near the mounting portion at which the hub bearing 28 is provided.

In addition, suspension bushings 60 are provided between the motor case 18 of the driving wheel 14 and the vehicle body 30. The suspension bushings 60 are fitted to the connecting portions between the suspension arms 24 and 26 and the motor case 18 and between the suspension arms 24 and 26 and the vehicle body 30 (that is, connecting portions between the unsprung vehicle body and the sprung vehicle body). Each suspension bushing 60 is, for example, an inner and outer cylindrical bushing. Each suspension bushing 60 includes an outer cylinder 62, an inner cylinder 64 and a rubber member 66. The outer cylinder 62 is coupled to the suspension arm 24 or 26, which serves as the unsprung vehicle body. The inner cylinder 64 is coupled to the vehicle body 30, which serves as the sprung vehicle body. The rubber member 66 is provided between the outer cylinder 62 and the inner cylinder 64, and functions as a damping member between the unsprung vehicle body and the sprung vehicle body. The suspension bushings 60 are press-fitted into mounting holes 68 provided for each of the suspension arms 24 and 26.

A conductive rubber (silicon rubber, or the like, as a material) containing carbon is used as a material for at least part of the rubber member 66. The conductive rubber has a conductivity lower than or equal to a predetermined volume resistivity (for example, 1×10⁻⁵ Ωm). Thus, the rubber member 66 has a function of reliably electrically connecting the suspension arm 24 or 26 to the vehicle body 30 or the motor case 18.

In the thus configured vehicle motor driving system 10, the inverter-side ends of the shield layers 44 of the three shielded wires 36 are insulated from the inverter case 38 by the insulating member 48. In addition, the motor-side ends of the shield layers 44 are connected to one another, and are insulated from the terminal block case 50 by the insulating member 56. The shield layers 44 are grounded near the connecting portions at which the motor case 18 is coupled to the suspension arms 24 and 26, and are grounded near the mounting portion at which the hub bearing 28 is provided.

With the configuration that the motor-side ends of the shield layers 44 of the shielded wires 36 are grounded near the connecting portions at which the motor case 18 is coupled to the suspension arms 24 and 26, when strong high-frequency noise is generated in the shielded wires 36 that are driving power cables, the high-frequency noise flows from the shield layers 44 to near the connecting portions at which the motor case 18 is coupled to the suspension arms 24 and 26, and then flows from the suspension arms 24 and 26 to the vehicle body 30 via the suspension bushings 60. That is, in order for the strong high-frequency noise generated in the shielded wires 36 to be transmitted to the vehicle body 30, the high-frequency noise needs to flow through the suspension bushings 60.

The suspension bushings 60 are provided at the connecting portions between the suspension arms 24 and 26 and the vehicle body 30 to allow a relative displacement therebetween as described above. Therefore, while the vehicle is driving, electrical resistances at the connecting portions between the suspension arms 24 and 26 and the vehicle body 30 are relatively high. Thus, with the above described configuration, by the time when high-frequency noise generated in the shielded wires 36 flows from the shield layers 44 to the vehicle body 30 via the motor case 18 and the suspension arms 24 and 26, the high-frequency noise may be attenuated by electrical resistance of each suspension bushing 60. Therefore, it is possible to suppress propagation of the high-frequency noise to the vehicle body 30, and also it is possible to prevent the high-frequency noise from being transmitted to another electrical component grounded to the vehicle body 30.

In addition, with the configuration that the motor-side ends of the shield layers 44 of the shielded wires 36 are grounded near the mounting portion at which the hub bearing 28 is provided in the motor case 18, when strong high-frequency noise is generated in the shielded wires 36 that are driving power cables, the high-frequency noise flows from the shield layers 44 to near the hub bearing mounting portion of the motor case 18, and then flows from the hub bearing 28 to a road surface via a rubber tire portion of the driving wheel 14. Thus, with the above configuration, it is possible to transfer high-frequency noise, generated in the shielded wires 36, to a road surface while attenuating the high-frequency noise by electrical resistance of the rubber tire portion of the driving wheel 14. Therefore, in terms of this point as well, it is possible to suppress propagation of the high-frequency noise to the vehicle body 30.

In this way, in the present embodiment, propagation of high-frequency noise, generated in the shielded wires 36, to the vehicle body 30 is suppressed by grounding the shield layers 44 of the shielded wires 36 as described above. Specifically, this configuration specifically sets a grounding point of the shield layers 44 to the motor case 18 near the connecting portions at which the shield layers 44 are connected to the suspension arms 24 and 26 and near the mounting portion at which the hub bearing 28 is provided. Thus, propagation of high-frequency noise to the vehicle body 30 is sufficiently suppressed only by specifically setting the grounding point of the shield layers 44 to the motor case 18 as described above. Hence, expensive and complex means, such as a high-frequency reactor, is not required. Therefore, with the vehicle motor driving system 10 according to the present embodiment, it is possible to suppress propagation of high-frequency noise, generated in the shielded wires 36, to the vehicle body 30 with a simple and low-cost configuration.

Note that, as described above, in the present embodiment, the suspension bushings 60 each have the rubber member 66 that serves as a damping member between the unsprung vehicle body and the sprung vehicle body, and the conductive rubber having a conductivity lower than or equal to a predetermined volume resistivity (for example, 1×10⁻⁵ Ωm) is used as a material for at least part of the rubber member. Therefore, with the vehicle motor driving system 10 according to the present embodiment, it is possible to reliably electrically connect the suspension arms 24 and 26 to the vehicle body 30 while attenuating high-frequency noise generated in the shielded wires 36 using the rubber members 66 of the suspension bushings 60.

Furthermore, with the configuration that the shield layers 44 of the shielded wires 36 are grounded near the suspension arm connecting portions of the motor case 18 and near the hub bearing mounting portion as described above, in the process in which high-frequency noise generated in the shielded wires 36 flows from the shield layers 44 to the vehicle body 30 or a road surface, the length of a path through which the high-frequency noise is transmitted to the motor case 18 itself reduces. Thus, with the above configuration, it is possible to suppress the influence of high-frequency noise, generated in the shielded wires 36, on a sensor itself present in the motor case 18 and a motor signal line that connects the sensor to an external controller. Therefore, with the vehicle motor driving system 10 according to the present embodiment, it is possible to suppress propagation of high-frequency noise, generated in the shielded wires 36, to the vehicle body 30 without exerting a large influence on the inside of the motor case 18 and the motor signal line.

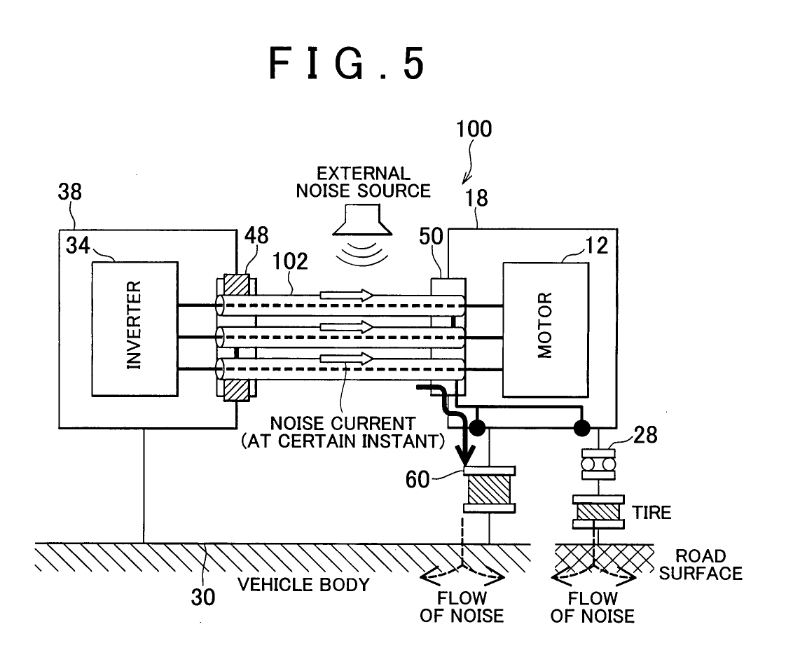

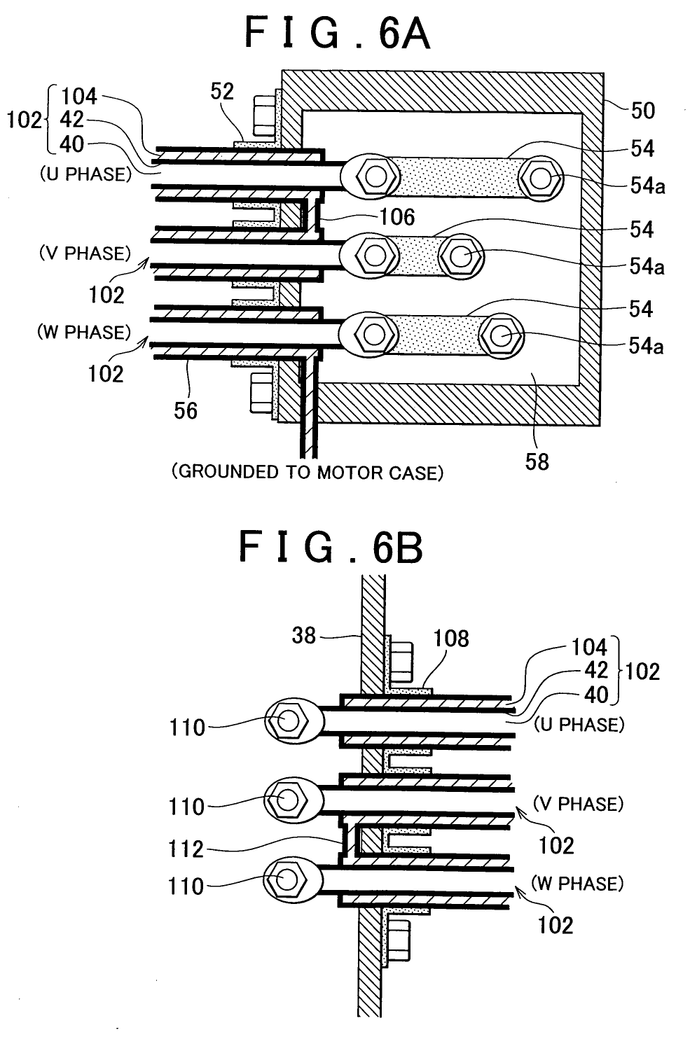

FIG. 5 is a configuration diagram of a vehicle motor driving system 100 according to a second embodiment of the invention. FIG. 6A and FIG. 6B are cross-sectional views of terminal block cases to which shielded wires of the vehicle motor driving system 100 according to the second embodiment are connected. Note that FIG. 6A shows a cross-sectional view of a terminal block case to which the motor-side ends of the shielded wires are connected, and FIG. 6B shows a cross-sectional view of a terminal block case to which the inverter-side ends of the shielded wires are connected. In addition, in FIG. 5, FIG. 6A and FIG. 6B, like reference numerals denote components similar to those of the configuration shown in FIG. 1 to FIG. 3, and the description thereof is omitted or simplified.

As shown in FIG. 5, the vehicle motor driving system 100 includes shielded wires 102 as power cables that connect the motor 12 to the inverter 34. The shielded wires 102 are power cables that are independently provided in correspondence with the three phases and that flow electric power of each phase from the inverter 34 to the motor 12. The shielded wires 102 are flexible and are able to follow a relative displacement between the inverter 34 and the motor 12 (that is, between the sprung vehicle body and the unsprung vehicle body).

Each shielded wire 102 includes a core wire 40, a cylindrical insulating member 42, and a shield layer 104. The insulating member 42 covers the core wire 40. The shield layer 104 covers the outer peripheral side of the insulating member 42. The shield layer 104 is formed of a conductive metal, and is, for example, formed by braiding metal thin wires on the outer peripheral side of the insulating member 42. The shield layer 104 has a function of shielding electromagnetic waves radiated from the core wire 40 to the outside.

In addition, the motor-side ends of the three shielded wires 102 are fixed to a terminal block case 50 by a cable mounting bracket 52, and are insulated from the terminal block case 50 by insulating members 42 and 56. The terminal block case 50 is integrally fixed to the motor case 18. The motor-side ends of the core wires 40 of the three shielded wires 102 are connected to corresponding bus bars 54 provided on an insulator 58 in the terminal block case 50.

The motor-side ends of the shield layers 104 of two shielded wires 102 among the three shielded wires 102 (for example, U-phase and V-phase shielded wires shown in FIG. 6A and FIG. 6B) are electrically connected to each other in the terminal block case 50. Hereinafter, the connecting portion at which the two shielded wires 102 are connected to each other is termed coupling portion 106. Note that the motor-side end of the shield layer 104 of the remaining one shielded wire 102 (for example, W-phase shielded wire) is not electrically connected to the shield layers 104 of the other two shielded wires 102.

In addition, the inverter-side ends of the three shielded wires 102 are fixed to the inverter case 38 by a cable mounting bracket 108, and are insulated from the inverter case 38 by the insulating members 42 and 48. The inverter-side ends of the core wires 40 of the three shielded wires 102 are connected to corresponding inverter output terminals 110 in the inverter case 38. These output terminals 110 are connected to cables that are connected to the inverter 34 in the inverter case 38.

The inverter-side end of the shield layer 104 of any one (for example, V-phase shielded wire) of two shielded wires 102 (for example, U-phase and V-phase shielded wires shown in FIG. 6A and FIG. 6B), of which the motor-side ends are electrically connected to each other, among the three shielded wires 102 is electrically connected to the inverter-side end of the shield layer 104 of the remaining one shielded wire 102 (for example, W-phase shielded wire) in the inverter case 38. Hereinafter, the connecting portion at which the above two shielded wires 102 are connected to each other is termed coupling portion 112. Note that the inverter-side end of the shield layer 104 of the other shielded wire 102 (for example, U-phase shielded wire) between the above described two shielded wires 102, of which the motor-side ends of the shield layers 104 are electrically connected to each other, is not electrically connected to the inverter-side ends of the shield layers 104 of the other two shielded wires 102.

The inverter-side ends of the shield layers 104 of the three shielded wires 102 are insulated from the inverter case 38, and the motor-side ends of the shield layers 104 are insulated from the terminal block case 50. On the other hand, the shield layers 44 are grounded near the connecting portions at which the motor case 18 is coupled to the suspension arms 24 and 26, and are grounded near the mounting portion at which the hub bearing 28 is provided.

In the thus configured vehicle motor driving system 100, the motor-side ends of the shield layers 104 of the three shielded wires 102 are insulated from the terminal block case 50 by the insulating member 56, and the motor-side ends of any two of the shield layers 104 of the shielded wires 102 are connected to each other by the coupling portion 106, while the inverter-side ends of the shield layers 104 of the shielded wires 102 are insulated from the inverter case 38 by the insulating member 48, and the inverter-side end of the remaining one phase shield layer 104 of the shielded wire 102 and the inverter-side end of any one of the two shield layers 104 of the shielded wires 102 that are connected by the coupling portion 106 are connected to each other by a coupling portion 112. Then, the motor-side end of the shield layer 104 of the remaining one shielded wire 102 is grounded near the suspension arm connecting portions of the motor case 18, and is grounded near the hub bearing mounting portion.

As a noise source outside the shielded wires 102 that are driving power cables generates noise, the noise is superimposed on the three shielded wires 102 and then noise current flows in the same direction between the motor 12 and the inverter 34 in the shield layers 104 of those shielded wires 102.

However, in the configuration that the shield layers 104 of the three shielded wires 102 are connected as described above, the overall length by which the shield layers 104 of the three shielded wires 102 are electrically continuous is one and half round trips between the motor 12 and the inverter 34. In the above configuration, when noise from an external noise source is superimposed on each of the three shielded wires 102, noise currents flowing through any two shielded wires 102 among the three shielded wires 102 (at least including the shielded wire 102 of which the motor-side end of the shield layer 104 is connected to the motor-side end of the shield layer 104 of another shielded wire 102 and the inverter-side end of the shield layer 104 is connected to the inverter-side end of the shield layer 104 of the other shielded wire 102) cancel each other to reduce noise received from the external noise source by the three shielded wires 102 as a whole to one third.

Thus, with the configuration according to the present embodiment, in comparison with a configuration that the three shielded wires 102 are merely arranged adjacent to one another between the motor 12 and the inverter 34 (specifically, a configuration with no staggered connection at the inverter-side ends and the motor-side ends of the shield layers 104 unlike the present embodiment), it is possible to suppress propagation of noise, generated outside, to the vehicle body 30 via the shielded wires 102. Thus, it is possible to prevent the noise from being transmitted to another electrical component grounded to the vehicle body 30 via the shielded wires 102.

In this way, in the present embodiment, propagation of noise, generated from an external noise source, to the vehicle body 30 via the shielded wires 102 is suppressed by connecting and grounding the shield layers 104 of the three shielded wires 102 as described above. Specifically, this configuration connects the motor-side ends of the shield layers 104 of any two of the shielded wires 102 to each other and connects the inverter-side end of the shield layer 104 of the remaining one shielded wire 102 to the inverter-side end of the shield layer 104 of any one of the other shielded wires 102, and then grounds the motor-side ends of the shield layers 104 of the shielded wires 102 near the connecting portions at which the motor case 18 is connected to the suspension arms 24 and 26 and near the mounting portion at which the hub bearing 28 is mounted. Thus, propagation of externally generated noise to the vehicle body 30 is sufficiently suppressed only by specifically setting connection and grounding of the shield layers 104 of the three shielded wires 102 as described above. Hence, expensive and complex means, such as a high-frequency reactor, is not required. Therefore, with the vehicle motor driving system 100 according to the present embodiment, it is possible to suppress propagation of noise, generated from an external noise source, to the vehicle body 30 via the shielded wires 102 with a simple and low-cost configuration.

Note that, in the present embodiment, noise received from an external noise source is reduced to one third as described above, and the noise flows to the shield layers 104, flows from the shield layers 104 to near the connecting portions at which the motor case 18 is connected to the suspension arms 24 and 26 and then flows from the suspension arms 24 and 26 to the vehicle body 30 via the suspension bushings 60, while the noise flows from the shield layers 104 to near the hub bearing mounting portion of the motor case 18 and then flows from the hub bearing 28 to a road surface via the rubber tire portion of the driving wheel 14.

Thus, with the configuration according to the present embodiment, by the time when noise from an external noise source flows from the shield layers 104 to the vehicle body 30 via the motor case 18 and the suspension arms 24 and 26, the noise may be attenuated by electrical resistance of each suspension bushing 60. In addition, it is possible to transfer noise from an external noise source to a road surface while attenuating the noise by electrical resistance of the rubber tire portion of the driving wheel 14. Thus, in terms of this point as well, it is possible to suppress propagation of noise from an external noise source to the vehicle body 30.

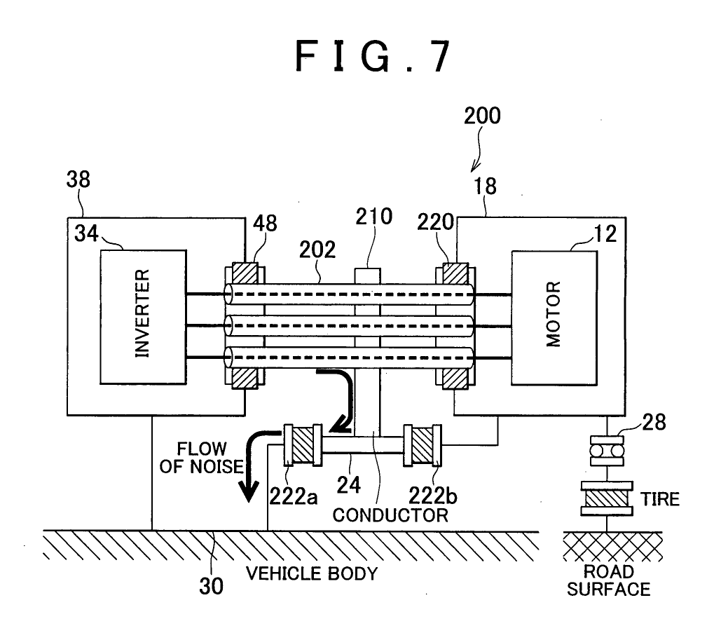

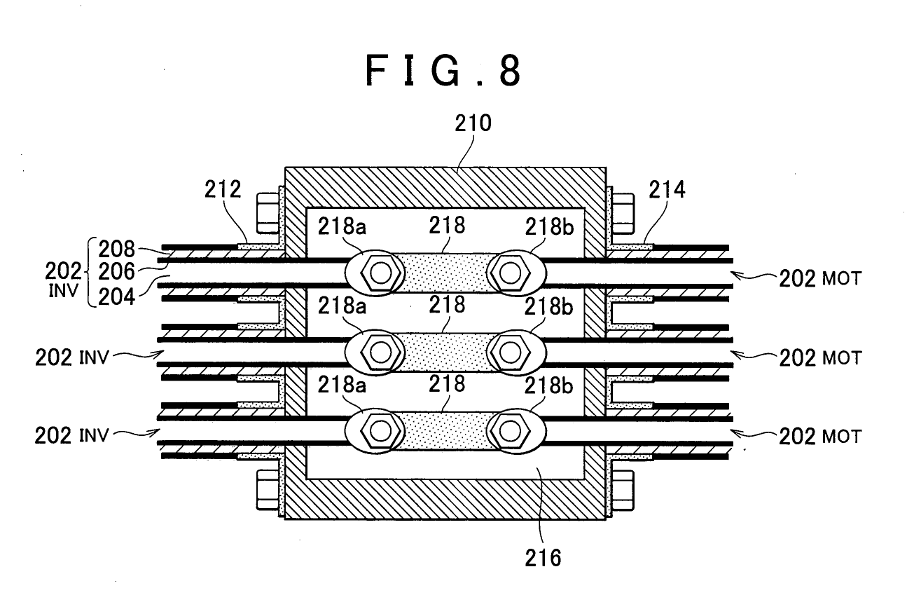

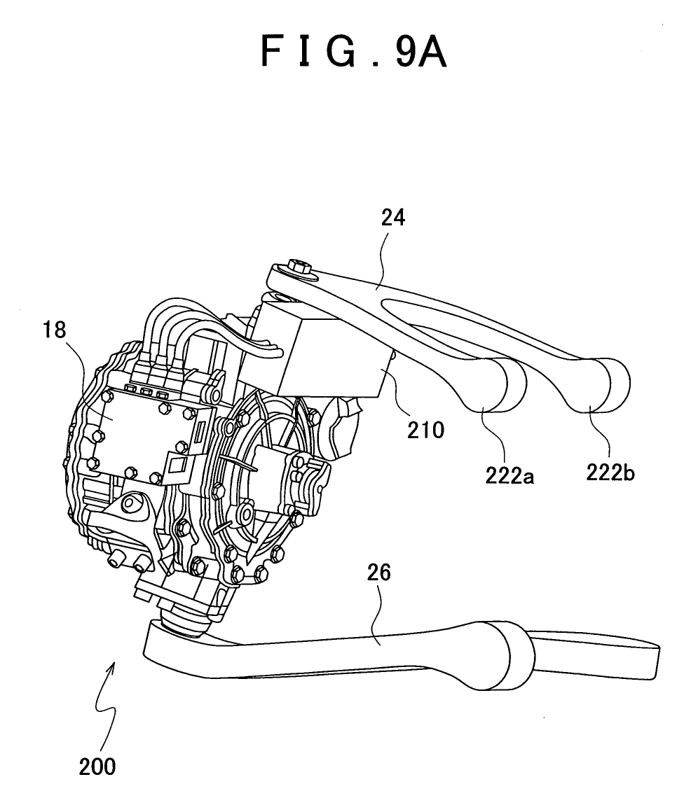

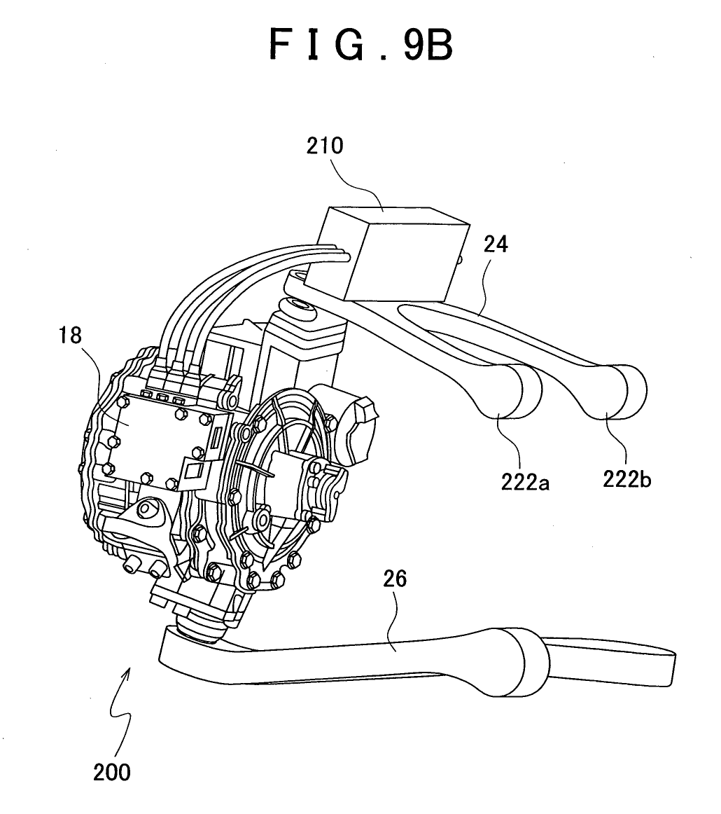

FIG. 7 is a configuration diagram of a vehicle motor driving system 200 according to a third embodiment of the invention. FIG. 8 is a cross-sectional view of a relay box case to which shielded wires of the vehicle motor driving system 200 according to the third embodiment are connected. FIG. 9A and FIG. 9B are perspective views of the overall vehicle motor driving system according to the third embodiment. Note that FIG. 9A and FIG. 9B respectively show perspective views of examples of the vehicle motor driving system 200. In addition, in FIG. 7 to FIG. 9B, like reference numerals denote components similar to those of the configuration shown in FIG. 1 to FIG. 3, and the description thereof is omitted or simplified.

As shown in FIG. 7, the vehicle motor driving system 200 includes shielded wires 202 as power cables that connect the motor 12 to the inverter 34. The shielded wires 202 are power cables that are independently provided in correspondence with the three phases and that flow electric power of each phase from the inverter 34 to the motor 12. The shielded wires 202 are flexible and are able to follow a relative displacement between the inverter 34 and the motor 12 (that is, between the sprung vehicle body and the unsprung vehicle body).

Each shielded wire 202 includes a core wire 204, a cylindrical insulating member 206, and a shield layer 208. The insulating member 206 covers the core wire 204. The shield layer 208 covers the outer peripheral side of the insulating member 206. The shield layer 208 is formed of a conductive metal, and is, for example, formed by braiding metal thin wires on the outer peripheral side of the insulating member 206. The shield layer 208 has a function of shielding electromagnetic waves radiated from the core wire 204 to the outside.

The shielded wires 202 are relayed by a relay box case 210, which serves as a conductive metal conductor, at midpoints thereof. That is, each shielded wire 202 is formed of a shielded wire 202_{INV} connected to the inverter 34 and a shielded wire 202_{MOT} connected to the motor 12. The motor-side ends of the three shielded wires 202_{INV} are fixed to the relay box case 210 by a cable mounting bracket 212, and the inverter-side ends of the three shielded wires 202_{MOT} are fixed to the relay box case 210 by a cable mounting bracket 214.

The motor-side ends of the core wires 204 of the three shielded wires 202_{INV} are insulated from the relay box case 210 by the insulating member 206, while being connected to corresponding bus bars 218 provided on an insulator 26 in the relay box case 210. In addition, the inverter-side ends of the core wires 204 of the three shielded wires 202_{MOT} are insulated from the relay box case 210 by the insulating member 206, while being connected to the corresponding bus bars 218 in the relay box case 210. The inverter-side terminal 218a of each bus bar 218 is connected to a corresponding one of the core wires 204 of the shielded wires 202_{INV}, the motor-side terminal 218b of each bus bar 218 is connected to a corresponding one of the core wires 204 of the shielded wires 202_{MOT}.

In addition, the motor-side ends of the shield layers 208 of the three shielded wires 202_{INV} are connected to the relay box case 210 and the cable mounting bracket 212. The inverter-side ends of the shield layers 208 of the three shielded wires 202_{MOT} are connected to the relay box case 210 and the cable mounting bracket 214. That is, the shield layers 208 of all the three shielded wires 202 are connected to the relay box case 210.

The inverter-side ends of the three shielded wires 202_{INV} are fixed to the inverter case 38 by a cable mounting bracket, and are insulated from the inverter case 38 by the insulating member 48. The inverter-side ends of the core wires 204 of the three shielded wires 202_{INV} are connected to corresponding inverter output terminals that are connected to cables connected to the inverter 34 in the inverter case 38.

In addition, the motor-side ends of the three shielded wires 202_{MOT} are fixed to the motor case 18 by a cable mounting bracket, and are insulated from the motor case 18 by an insulating member 220. The motor-side ends of the core wires 204 of the three shielded wires 202_{MOT} are connected to corresponding motor output terminals that are connected to cables connected to the motor 12 in the motor case 18.

As shown in FIG. 9A and FIG. 9B, the relay box case 210 is fixedly mounted on the upper suspension arm 24. The relay box case 210 is fixedly mounted at a middle portion of the suspension arm 24 to which suspension bushings 222a and 222b are connected. The suspension bushing 222a is located at a portion at which the suspension arm 24 is connected to the vehicle body 30. In addition, the suspension bushing 222b is located at a portion at which the suspension arm 24 is connected to the motor case 18. Note that at least the suspension bushing 222a may have the rubber member 66 that partially uses conductive rubber as a material as in the case of the above described suspension bushing 60. In this case, it is possible to reliably electrically connect the suspension arm 24 to the vehicle body 30.

Note that the relay box case 210 may be fixedly mounted on the lower suspension arm 26. In this case as well, the relay box case 210 is fixedly mounted at a middle portion of the suspension arm 26 on which bushings are respectively formed at both ends.

In the thus configured vehicle motor driving system 200, the inverter-side ends of the shield layers 208 of the three shielded wires 202 are insulated from the inverter case 38 by the insulating member 48, and the motor-side ends of the shield layers 208 are insulated from the motor case 18 by the insulating member 220. On the other hand, the shield layers 208 are connected to the relay box case 210 between the motor 12 and the inverter 34, and are grounded to the suspension arm 24, on which the suspension bushings 222a and 222b are formed at both ends, via the relay box case 210.

In the above configuration, when strong high-frequency noise is generated in the shielded wires 202 that are driving power cables, the high-frequency noise does not directly flow to the inverter case 38 or the motor case 18, but the high-frequency noise flows from the shield layers 208 to the suspension arm 24 via the relay box case 210 and then flows from the suspension arm 24 to the vehicle body 30 or the motor case 18 via the suspension bushing 222a or 222b. That is, in order for the high-frequency noise generated in the shielded wires 202 to be transmitted to the vehicle body 30 or the motor case 18, the high-frequency noise needs to flow through the suspension bushing 222a or 222b.

The suspension bushings 222a and 222b are provided at the connecting portion between the suspension arm 24 and the vehicle body 30 and at the connecting portion between the suspension arm 24 and the motor case 18 to allow a relative displacement therebetween. Therefore, while the vehicle is driving, electrical resistances at the connecting portions between the suspension arm 24 and the vehicle body 30 and between the suspension arm 24 and the motor case 18 are relatively high. Thus, with the above described configuration, by the time when high-frequency noise generated in the shielded wires 202 flows from the shield layers 208 to the vehicle body 30 or the motor case 18 via the relay box case 210 and the suspension arm 24, the high-frequency noise may be attenuated by electrical resistance of the suspension bushing 222a or 222b. Therefore, it is possible to suppress propagation of the high-frequency noise to the vehicle body 30 or the motor case 18, and also it is possible to prevent the high-frequency noise from being transmitted to another electrical component grounded to the vehicle body 30, a sensor present in the motor case 18 or a motor signal line that connects the sensor to an external controller.

In this way, in the present embodiment, propagation of high-frequency noise, generated in the shielded wires 202, to the vehicle body 30 or the motor case 18 is suppressed by insulating and grounding the shield layers 208 of the shielded wires 202 as described above. Specifically, this configuration insulates the shield layers 208 from the motor case 18 and the inverter case 38 while grounding the shield layers 208 at midpoints thereof to the suspension arm 24, on which the suspension bushings 222a and 222b are provided at both ends, via the relay box case 210. Thus, propagation of high-frequency noise to the vehicle body 30 or the motor case 18 is sufficiently suppressed only by specifically setting the insulation and grounding of the shield layers 208 as described above. Hence, expensive and complex means, such as a high-frequency reactor, is not required. Therefore, with the vehicle motor driving system 200 according to the present embodiment, it is possible to suppress propagation of high-frequency noise, generated in the shielded wires 202, to the vehicle body 30 or the motor case 18 with a simple and low-cost configuration.

Note that in the above third embodiment, the relay box case 210 corresponds to a “relay conductor” according to the aspect of the invention.

Incidentally, in the above third embodiment, the shield layers 208 of the shielded wires 202 are grounded to the suspension arm 24, on which the suspension bushings 222a and 222b are provided at both ends, via the relay box case 210; instead, the shield layers 208 may be grounded to a stabilizer or a suspension member, on each of which bushings are provided at both ends.

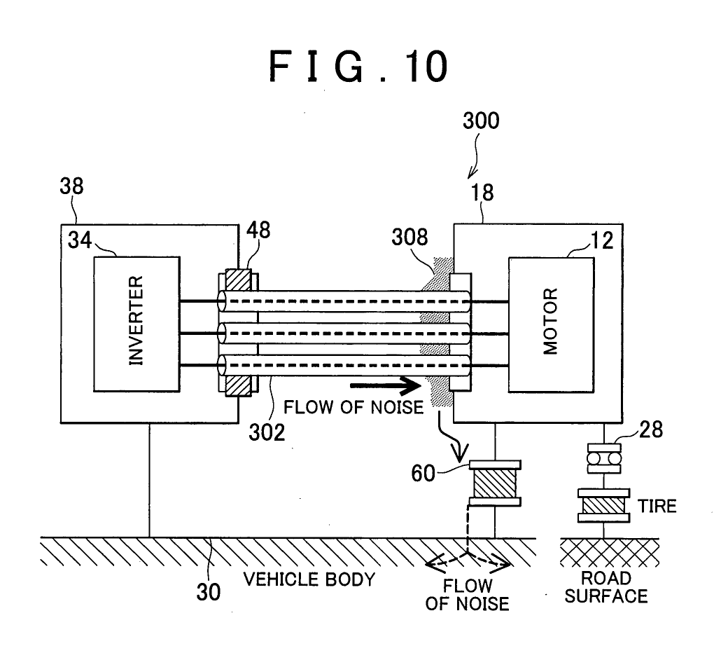

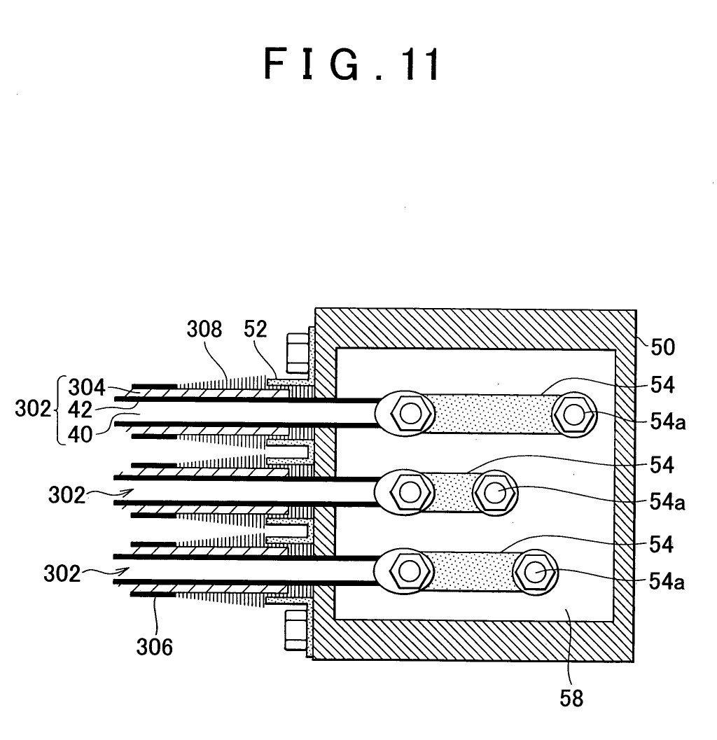

FIG. 10 is a configuration diagram of a vehicle motor driving system 300 according to a fourth embodiment of the invention. FIG. 11 is a cross-sectional view of a terminal block case to which shielded wires of the vehicle motor driving system 300 according to the fourth embodiment are connected. Note that, in FIG. 10 and FIG. 11, like reference numerals denote components similar to those of the configuration shown in FIG. 2 and FIG. 3, and the description thereof is omitted or simplified.

As shown in FIG. 10, the vehicle motor driving system 300 includes shielded wires 302 as power cables that connect the motor 12 to the inverter 34. The shielded wires 302 are power cables that are independently provided in correspondence with the three phases and that flow electric power of each phase from the inverter 34 to the motor 12. The shielded wires 302 are flexible and are able to follow a relative displacement between the inverter 34 and the motor 12 (that is, between the sprung vehicle body and the unsprung vehicle body).

Each shielded wire 302 includes a core wire 40, a cylindrical insulating member 42, and a shield layer 304. The insulating member 42 covers the core wire 40. The shield layer 304 covers the outer peripheral side of the insulating member 42. The shield layer 304 is formed of a conductive metal, and is, for example, formed by braiding metal thin wires on the outer peripheral side of the insulating member 42. The shield layer 304 has a function of shielding electromagnetic waves radiated from the core wire 40 to the outside.

The inverter-side ends of the three shielded wires 302 are fixed to the inverter case 38 by a cable mounting bracket, and are insulated from the inverter case 38 by the insulating member 48. The inverter-side ends of the core wires 40 of the three shielded wires 302 are connected to corresponding inverter output terminals in the inverter case 38.

In addition, the motor-side ends of the three shielded wires 302 are fixed to the terminal block case 50 by the cable mounting bracket 52. The motor-side ends of the core wires 40 of the three shielded wires 302 are insulated from the terminal block case 50 by the insulating member 42 and are connected to corresponding bus bars 54 in the terminal block case 50. The outer peripheries of the shield layers 304 of the three shielded wires 302 are covered with the insulating member 306, and the motor-side ends of the shield layers 304 are in contact with the cable mounting bracket 52 and the terminal block case 50 via the rubber member 308. The rubber member 308 has elasticity for allowing flexure of the shielded wires 302 and functions as part of a fixture that fixes the motor-side ends of the shielded wires 302 to the terminal block case 50 (that is, motor case 18).

A conductive rubber (silicon rubber, or the like, as a material) containing carbon is used as a material for the rubber member 308. The conductive rubber has a conductivity lower than or equal to a predetermined volume resistivity (for example, 1×10⁻⁵ Ωm), and has a volume resistivity lower than the volume resistivity of the insulating member 48 located at the inverter side. The rubber member 308 has a function of reliably electrically connecting the shield layers 304 of the shielded wires 302 to the motor case 18.

In the thus configured vehicle motor driving system 300, the inverter-side ends of the shield layers 304 of the three shielded wires 302 are insulated from the inverter case 38 by the insulating member 48, and the motor-side ends of the shield layers 304 are grounded to the terminal block case 50 (that is, motor case 18) via the rubber member 308.

The rubber member 308 has elasticity as described above. Thus, with the above configuration, flexure of the shielded wires 302 is allowed. Therefore, it is possible to ensure flexibility of electrical connection between the inverter 34 and the motor 12 by allowing a relative displacement between the sprung vehicle body and the unsprung vehicle body. Hence, it is possible to improve durability of the shielded wires 302. In addition, the rubber member 308 has a conductivity having a relatively low volume resistivity as described above. Thus, with the above configuration, the shield layers 304 may be reliably electrically connected to the motor case 18, while, when strong high-frequency noise is generated in the shielded wires 302 that are driving power cables, the high-frequency noise transmitted to the motor case 18 may be attenuated.

The high-frequency noise transmitted from the shielded wires 302 to the motor case 18 flows to the vehicle body 30 via the suspension bushings 60 and then flows to a road surface via the hub bearing 28. Thus, the high-frequency noise is attenuated by the time when the high-frequency noise reaches the vehicle body 30, and part of the high-frequency noise is transferred to a road surface. Thus, it is possible to suppress propagation of high-frequency noise, generated in the shielded wires 302, to the vehicle body 30.

In this way, in the present embodiment, propagation of high-frequency noise, generated in the shielded wires 302, to the vehicle body 30 is suppressed by connecting the motor-side ends of the shield layers 304 of the shielded wires 302 to the motor case 18 via the rubber member 308 as described above. Thus, propagation of high-frequency noise to the vehicle body 30 is sufficiently suppressed only by specifically setting connection of the shield layers 304 to the motor case 18 as described above. Hence, expensive and complex means, such as a high-frequency reactor, is not required. Therefore, with the vehicle motor driving system 300 according to the present embodiment, it is possible to ensure flexibility of electrical connection between the inverter 34 and the motor 12 and durability of the shielded wires 302 while suppressing propagation of high-frequency noise, generated in the shielded wires 302, to the vehicle body 30 with a simple and low-cost configuration.

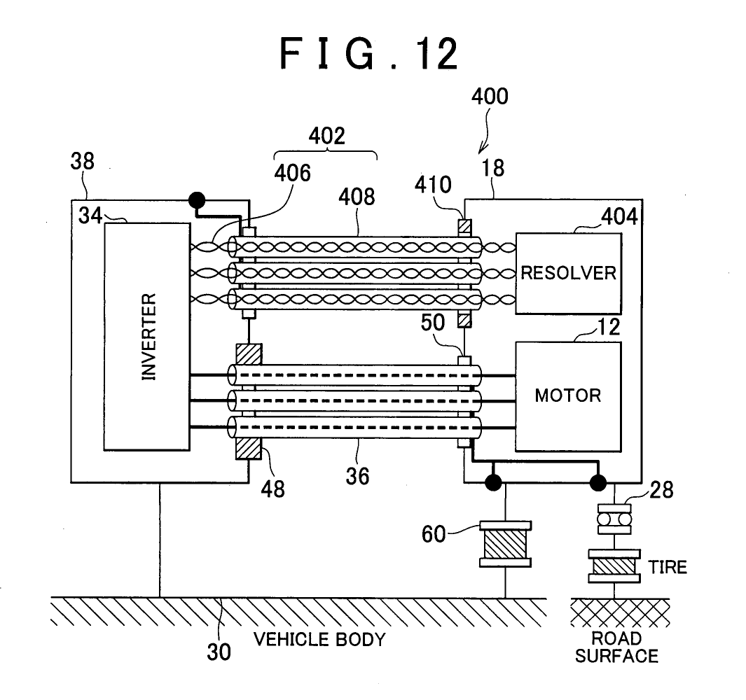

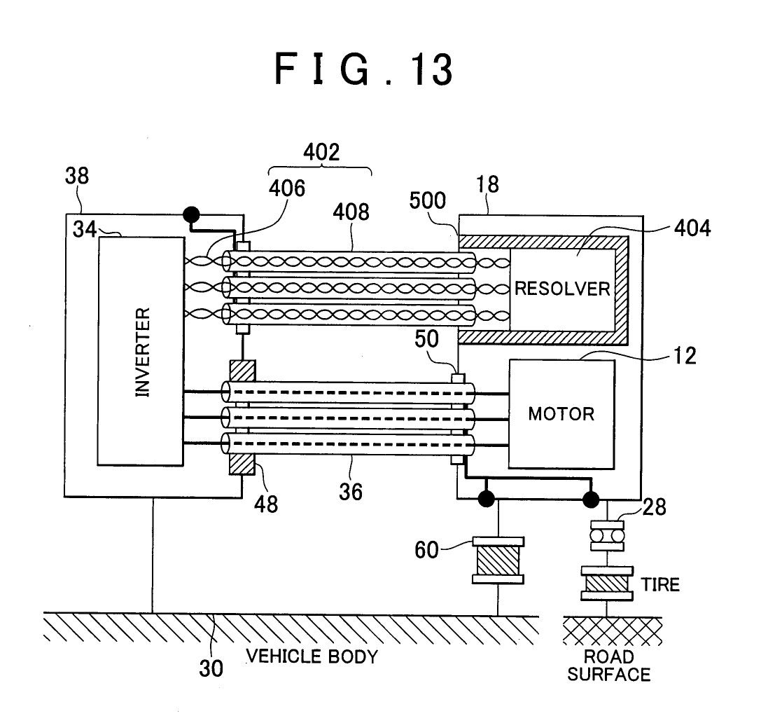

FIG. 12 is a configuration diagram of a vehicle motor driving system 400 according to a fifth embodiment of the invention. In addition, in FIG. 12, like reference numerals denote components similar to those of the configuration shown in FIG. 1 to FIG. 3, and the description thereof is omitted or simplified.

As shown in FIG. 12, the vehicle motor driving system 400 includes shielded wires 36 as power cables and shielded wires 402 as signal cables. The shielded wires 36 connect the motor 12 to the inverter 34. Hereinafter, the shielded wires 36 as power cables are termed power feeding shielded wires 36, and the shielded wires 402 as signal cables are termed signal shielded wires 402.

The signal shielded wires 402 are signal cables that connect a resolver 404, provided in the motor case 18, to the inverter 34. The three signal shielded wires 402 are independently provided in correspondence with the respective phases of the resolver 404. The signal shielded wires 402 exchanges signals having a low voltage than that of the power feeding shielded wires 36 between the resolver 404 and the inverter 34. The signal shielded wires 402 are flexible and are able to follow a relative displacement between the inverter 34 and the resolver 404 (that is, between the sprung vehicle body and the unsprung vehicle body).

Each signal shielded wire 402 includes a signal line 406, a cylindrical insulating member and a shield layer 408. The insulating member covers the signal line 406. The shield layer 408 covers the outer peripheral side of the insulating member. The shield layer 408 is formed of a conductive metal, and is, for example, formed by braiding metal thin wires on the outer peripheral side of the insulating member 42. The shield layer 408 has a function of shielding electromagnetic waves radiated from the signal line 406 to the outside.

The motor-side ends of the three signal shielded wires 402 are fixed to the motor case 18 by a cable mounting bracket, and are insulated from the motor case 18 by an insulating member 410. The motor-side ends of the signal lines 406 of the three signal shielded wires 402 are connected to the resolver 404 in the motor case 18.

In addition, the inverter-side ends of the three signal shielded wires 402 are fixed to the inverter case 38 by a cable mounting bracket. The inverter-side ends of the signal lines 406 of the three signal shielded wires 402 are insulated from the inverter case 38 by an insulating member, and are connected to the inverter 34 in the inverter case 38. The inverter-side ends of the shield layers 408 of the three signal shielded wires 402 are electrically connected to one another in the inverter case 38, and are grounded to the inverter case 38 (furthermore, a location that is farther from the connecting portion at which the inverter case 38 is connected to the vehicle body 30 as much as possible).

In the thus configured vehicle motor driving system 400, the inverter-side ends of the shield layers 44 of the three power feeding shielded wires 36 are insulated from the inverter case 38 by the insulating member 48. In addition, the motor-side ends of the shield layers 44 are connected to one another, and are insulated from the terminal block case 50 by the insulating member 56. The shield layers 44 are grounded near the connecting portions at which the motor case 18 is coupled to the suspension arms 24 and 26, and are grounded near the mounting portion at which the hub bearing 28 is provided. With the above configuration, it is possible to suppress propagation of high-frequency noise, generated in the power feeding shielded wires 36, to the vehicle body 30, and it is possible to prevent high-frequency noise from being transmitted to another electrical component grounded to the vehicle body 30.

In addition, in the thus configured vehicle motor driving system 400, the motor-side ends of the shield layers 408 of the signal shielded wires 402 are insulated from the motor case 18 by the insulating member 410. In addition, the inverter-side ends of the shield layers 408 are connected to one another and are grounded to the inverter case 38. That is, the shield layers 44 of the power feeding shielded wires 36 are grounded to the motor case 18, and the shield layers 408 of the signal shielded wires 402 are insulated from the motor case 18. In addition, the shield layers 44 of the power feeding shielded wires 36 are insulated from the inverter case 38, and the shield layers 408 of the signal shielded wires 402 are grounded to the inverter case 38.

In the above configuration, when high-frequency noise is generated in the power feeding shielded wires 36 that handle a relatively high voltage, even when the high-frequency noise is transmitted to the motor case 18, it is hard for the high-frequency noise to be transmitted to the signal shielded wires 402 (both the signal lines 406 and the shield layers 408) via the motor case 18. In addition, even when the high-frequency noise is transmitted to the vehicle body 30 via the motor case 18 and the suspension bushings 60, the high-frequency noise is attenuated by a large amount by that time, so similarly it is hard for the high-frequency noise to be transmitted to the signal shielded wires 402 via the inverter case 38. Therefore, with the present embodiment, it is possible to suppress the influence of high-frequency noise, generated in the power feeding shielded wires 36, on the signal lines 406 and shield layers 408 of the signal shielded wires 402.

In this way, in the present embodiment, propagation of high-frequency noise generated in the power feeding shielded wires 36 to the vehicle body 30 and to the signal shielded wires 402 are suppressed by insulating and grounding the shield layers 44 and 408 of the shielded wires 36 and 402. Thus, propagation of high-frequency noise to the vehicle body 30 or to the signal shielded wires 402 is sufficiently suppressed only by specifically setting the grounding points of the shield layers 44 and 408 of the shielded wires 36 and 402 to the motor case 18 and to the inverter case 38 as described above. Hence, expensive and complex means, such as a high-frequency reactor, is not required. Therefore, with the vehicle motor driving system 400 according to the present embodiment, it is possible to suppress propagation of high-frequency noise, generated in the power feeding shielded wires 36, to both the vehicle body 30 and the signal shielded wires 402 with a simple and low-cost configuration.

Note that in the above fifth embodiment, the shield layers 44 of the power feeding shielded wires 36 are grounded to the motor case 18, so noise component may flow to the motor case 18 and then the noise component may be superimposed on near the connecting point at which the signal lines 406 are connected to the resolver 404 or the resolver 404 itself.

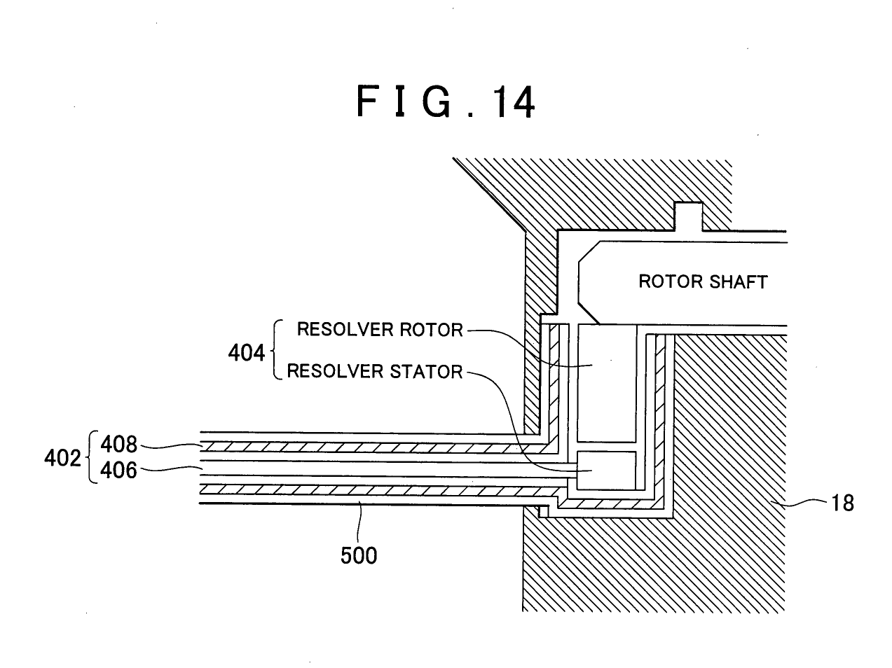

Then, as shown in FIG. 13 and FIG. 14, an insulating member 500 may be provided to cover the resolver 404 and the signal shielded wires 402 in the motor case 18. With the above configuration, the signal shielded wires 402 and the resolver 404 may be electrically isolated from another portion of the motor case 18, and the shield layers 408 of the signal shielded wires 402 may be set at a ground potential equal to that of the vehicle body 30. Thus, the resolver 404 and its surroundings in the motor case 18 may be located electrically away from the shield layers 44 of the power feeding shielded wires 36. Therefore, the resolver 404 and its surroundings may be placed in a state where electrical noise is smaller than that of the motor case 18 itself. Hence, it is less likely that high-frequency noise generated in the power feeding shielded wires 402 influences the resolver 404 and its surroundings, and it is possible to ensure stable operation of the resolver 404. Note that it is not limited to the configuration that the resolver 404 and the signal shielded wires 402 are covered with the single-piece insulating member 500; instead, the resolver 404 and the signal shielded wires 402 may be respectively covered with separate insulating members.

Note that in this alternative embodiment, the resolver 404 and the signal lines 406 may be regarded as “sensors” according to the aspect of the invention.

In addition, in the above fifth embodiment, the resolver 404 is provided in the motor case 18 as sensors, and the signal shielded wires 402 are provided to connect the resolver 404 to the inverter 34; instead, it is also applicable that a temperature sensor, or the like, is provided in the motor case 18 and then a signal shielded wire that connects the temperature sensor to the inverter 34 is provided.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

1. A vehicle motor driving system that includes a motor that is installed to an unsprung vehicle body and that generates power for rotating a wheel by being fed with electric power, an inverter that is installed to a sprung vehicle body and that converts direct-current electric power into alternating-current electric power and then feeds the electric power to the motor, and a shielded wire as a power cable that electrically connects the motor to the inverter, wherein:
a shield layer of the shielded wire is grounded at least one of a location near a connecting portion at which a motor case that accommodates the motor is connected to a suspension arm and a location near a mounting portion at which a hub bearing is mounted in the motor case.

2. The vehicle motor driving system according to claim 1, wherein
the motor is a three-phase alternating-current motor,
the number of the shielded wires is three, and the three shielded wires are independently provided respectively for three phases of the three-phase alternating-current motor,
motor-side ends of the shield layers of the two shielded wires among the three shielded wires are connected to each other,
inverter-side ends of the shield layer of any one of the two shielded wires, of which the motor-side ends of the shield layers are connected, and the shield layer of the remaining one shielded wire among the three shielded wires are connected to each other, and
the motor-side end of the shield layer of the remaining one shielded wire independent of the motor-side ends of the other shield layers is grounded at least any one of the location near the connecting portion at which the motor case is connected to the suspension arm and the location near the mounting portion at which the hub bearing is mounted in the motor case.

3. A vehicle motor driving system that includes a motor that is installed an unsprung vehicle body and that generates power for rotating a wheel by being fed with electric power, an inverter that is installed to a sprung vehicle body and that converts direct-current electric power into alternating-current electric power and then feeds the electric power to the motor, and a shielded wire as a power cable that electrically connects the motor to the inverter, wherein:
a shield layer of the shielded wire is grounded via a relay conductor to at least one of a suspension arm, a stabilizer and a suspension member, on each of which bushings are respectively provided at both ends.

4. The vehicle motor driving system according to claim 3, wherein
the relay conductor is arranged at a middle location between the motor and the inverter, and
the relay conductor relays a shielded wire, which electrically connects the motor to the relay conductor, to a shielded wire, which electrically connects the inverter to the relay conductor.

5. A vehicle motor driving system that includes a motor that is installed to an unsprung vehicle body and that generates power for rotating a wheel by being fed with electric power, an inverter that is installed to a sprung vehicle body and that converts direct-current electric power into alternating-current electric power and then feeds the electric power to the motor, and a shielded wire as a power cable that electrically connects the motor to the inverter, comprising:
a rubber member that is part of a fixture for fixing one end of the shielded wire to a motor case that accommodates the motor, that is connected to a shield layer of the shielded wire, and that has a conductivity lower than or equal to a predetermined volume resistivity, wherein
the shield layer of the shielded wire is grounded to the motor case via the rubber member.

6. The vehicle motor driving system according to claim 5, wherein the predetermined volume resistivity is about 1×10⁻⁵ Ωm.

7. The vehicle motor driving system according to claim 5, wherein the rubber member is silicon rubber.

8. The vehicle motor driving system according to claim 1, wherein a suspension bushing, provided at a connecting portion at which the unsprung vehicle body is connected to the sprung vehicle body, has a rubber member as part of the suspension bushing, and the rubber member has a conductivity lower than or equal to a predetermined volume resistivity.

9. The vehicle motor driving system according to claim 8, wherein the predetermined volume resistivity is about 1×10⁻⁵ Ωm.

10. The vehicle motor driving system according to claim 8, wherein the rubber member is silicon rubber.

11. A vehicle motor driving system that includes a motor that is installed to an unsprung vehicle body and that generates power for rotating a wheel by being fed with electric power, an inverter that is installed to a sprung vehicle body and that converts direct-current electric power into alternating-current electric power and then feeds the electric power to the motor, a power feeding shielded wire as a power cable that electrically connects the motor to the inverter, sensors that are arranged in a motor case that accommodates the motor, a controller that is installed to the sprung vehicle body, and a signal shielded wire as a signal line that electrically connects the sensors to the controller, wherein:
a shield layer of the power feeding shielded wire is grounded at least one of a location near a connecting portion at which the motor case is connected to a suspension arm and a location near a mounting portion at which a hub bearing is mounted in the motor case, and
a shield layer of the signal shielded wire is grounded to the sprung vehicle body.

12. The vehicle motor driving system according to claim 11, wherein an inverter-side end of the power feeding shielded wire is insulated from the sprung vehicle body, and a motor-side end of the signal shielded wire is insulated from the unsprung vehicle body.

13. The vehicle motor driving system according to claim 11, further comprising an insulating member that covers the sensors so as to electrically isolate the sensors from the motor case.

14. The vehicle motor driving system according to claim 3, wherein a suspension bushing, provided at a connecting portion at which the unsprung vehicle body is connected to the sprung vehicle body, has a rubber member as part of the suspension bushing, and the rubber member has a conductivity lower than or equal to a predetermined volume resistivity.

15. The vehicle motor driving system according to claim 14, wherein the predetermined volume resistivity is about 1×10⁻⁵ Ωm.

16. The vehicle motor driving system according to claim 14, wherein the rubber member is silicon rubber.

17. The vehicle motor driving system according to claim 5, wherein a suspension bushing, provided at a connecting portion at which the unsprung vehicle body is connected to the sprung vehicle body, has a rubber member as part of the suspension bushing, and the rubber member has a conductivity lower than or equal to a predetermined volume resistivity.

18. The vehicle motor driving system according to claim 17, wherein the predetermined volume resistivity is about 1×10⁻⁵ Ωm.

19. The vehicle motor driving system according to claim 17, wherein the rubber member is silicon rubber.
